(19) United States
(12) Patent Application Publication
(10) Pub. No.: US 2016/0207140 A1
(43) Pub. Date: Jul. 21, 2016

(54) METHOD FOR JOINING DISSIMILAR METAL PARTS FOR IMPROVED WELDABILITY, WELD QUALITY, MECHANICAL PERFORMANCE

(71) Applicant: THE REGENTS OF THE UNIVERSITY OF MICHIGAN, Ann Arbor, MI (US)

(72) Inventors: Pingsha DONG, Ann Arbor, MI (US); Shaopin SONG, Ann Arbor, MI (US); Xianjun PEI, Ann Arbor, MI (US)

(21) Appl. No.: 15/000,364

(22) Filed: Jan. 19, 2016

Related U.S. Application Data
(60) Provisional application No. 62/104,982, filed on Jan. 19, 2015.

(51) Int. Cl. B23K 20/227; B23K 20/24

(52) U.S. Cl. CPC B23K 20/2275; B23K 20/24; B23K 2203/20

(57) ABSTRACT

A method that improves the weldability, weld quality and mechanical performance of components involving concentric parts or non-concentric parts with closed weld seams of dissimilar metals and uses a temperature differential concept on one of the parts or both of the parts to be joined is proposed. This method results in improved weldability, prevents weld cracking both during and after welding, and significantly improves structural performance in terms of static, fatigue, and dynamic strengths. For dissimilar metal joints that are prone to formation of intermetallics, the differential temperature technique can significantly reduce the detrimental effects of intermetallics on mechanical performance of joints, as a result of favorable stress state generated by the temperature differential.

### CROSS-REFERENCE TO RELATED APPLICATIONS

This application claims the benefit of U.S. Provisional Application No. 62/104,982, filed on Jan. 19, 2015. The entire disclosure of the above application is incorporated herein by reference.

### FIELD

The present disclosure relates to a method for joining parts with a closed bond line or a closed weld seam, such as a circumferential weld, for improved weldability, weld quality, and mechanical performance.

### BACKGROUND AND SUMMARY

This section provides background information related to the present disclosure which is not necessarily prior art. This section provides a general summary of the disclosure, and is not a comprehensive disclosure of its full scope or all of its features.

Concentric parts of metallic materials (particularly high-strength metals) or dissimilar metals need to be welded and/or joined together through fusion welding (e.g., laser, any arc welding processes) or any solid state joining processes (brazing, friction, diffusion) for certain components or non-concentric parts involving closed weld seams. Due to high restraint conditions and/or poor weldability (e.g., high-strength metallic materials, aluminum to steel and titanium to steel joining), welding/joining processes on parts of similar configurations often cause weld cracking during and after welding, and weldability-related quality problems, such as extensive intermetallic formation that remain a major unresolved issue in the industry.

To deal with some of these issues in some specific applications, there are two general approaches at present, depending on materials to be joined. (1) in welding/joining involving high strength metal parts that exhibit poor weldability, e.g., gear components, traditional pre-heating of parts prior to welding to sufficiently reduce cooling rate is either ineffective due to parts' high hardenability or would require a too high pre-heat/post-heat temperature that could cause degradation of material properties, e.g., in gear components; (2) in welding/joining ferrous to non-ferrous metals, such as steel to aluminum, researchers and industrial practitioners have attempted methods ranging from using high energy density welding techniques such as laser welding with more precise control of welding heat input, heating rate, and cooling rate or solid state joining processes such as friction welding, friction stir welding, diffusion bounding, brazing. In general, none of the techniques have been proven effective for industrial applications due to formation of intermetallics that are too brittle to offer any useful load capability. Therefore, research on improved weldability, weld quality and product performance of metallic (particularly high-strength metals) or dissimilar metals has the potential to impact the Global Welding Market for manufacture of products that increasingly requires lightweight and structural reliability.

The present teachings significantly improve weldability of such components, particularly for joining high-strength steel parts and dissimilar metal parts. In some embodiments, the present teachings employ a temperature differential concept that is based on the temperature difference established between parts to be joined, rather than establishing a pre-heat/post-heat temperature applied to both parts to be joined in traditional pre-heating/post-heating method. The temperature differential joining technique only requires preheating one of the two parts to be joined to a temperature level lower than that used in traditional pre-heating/post-heating methods which may only be applicable for joining high strength steel parts, not applicable for joining dissimilar materials.

The closest technique used by industry is a pre-heating/post-heating welding technique for joining high-strength steel parts, which typically uses a higher temperature than that used in the present teachings and is applied on all parts to be welded. The temperature differential used here is to promote desirable thermomechanical interactions between metal parts to be joined, rather than to reduce cooling rate at a temperature regime between 800° C. and 500° C. as intended in any pre-heating/post-heating methods.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates two parts to be welded together along a circumferential seam with respect to component axis. The joint seam orientation can be at an angle with respect to component axis.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the FIGURE. Spatially relative terms may be intended to encompass different orientations of the device in use or operation in addition to the orientation depicted in the FIGURE. For example, if the device in the FIGURE is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

According to some embodiments, the present teachings may find particular utility in a wide range of applications, including: powertrain or power transfer components in cars, trucks, trains, and other transportation systems; axle components; rotating equipment, such as air compressors; concentric parts that need to be welded or joined together, which otherwise tend to cause cracking or poor weld quality, such as tube-to-tube joints, tube-to-fitting joints, pipe-to-pipe and pipe-to-fitting joints, involving dissimilar metals; and other applications requiring the joining of dissimilar materials.

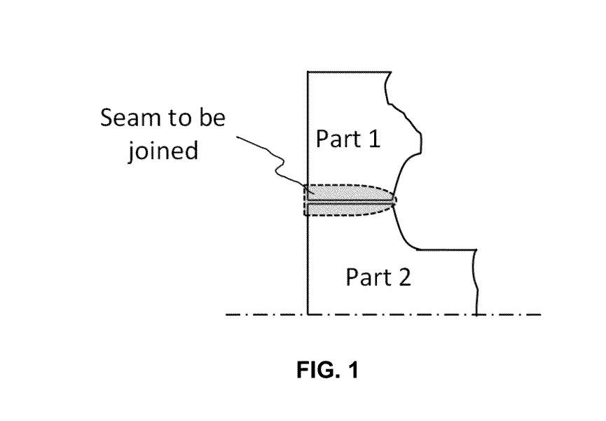

Generally, the present teachings provide a method of joining dissimilar metal parts, Part 1 or first member and Part 2 or second member, with a closed bond/weld seam as illustrated in FIG. 1. The method generally includes providing and/or positioning the first member and the second concentrically relative to each other. In some embodiments, the first member is preheated to a first temperature above ambient temperature. However, in some embodiments, the first member can be preheated to any temperature above the temperature of the second member. In some embodiments, the temperature of the first member is maintained at a temperature less than the temperature that may cause degradation of material properties in the first member. By way of illustration, such degradation in material properties may include, but are not limited to, e.g., reduction in strength, toughness, surface hardness, etc. The level of acceptable degradation in material properties is determined by known engineering principles and is dependent upon the specific material application and usage. Therefore, this temperature boundary from acceptable material degradation will be determined by one skilled in the art. In some embodiments, the method further includes maintaining the second member at a second temperature equal to ambient temperature. However, in some embodiments, the method can include maintaining the second member at a temperature above, below, or at ambient temperature, so long as a sufficient temperature differential (ΔT) is achieved between the first member and the second member. In some embodiments, this temperature differential (ΔT) can be maintained even when the absolute temperature of the first member and/or second member varies. The method further includes welding the first member and the second member together while the first member is at the first temperature and the second member is at the second temperature.

In some embodiments, the temperature differential (ΔT) according to the principles of the present teachings is effective for preventing weld cracking during and after welding, and improving weld quality. In some embodiments, the temperature differential (ΔT) is determined either through trial-and-error or quantitatively through the following first-principle based expression:

$$m \times material yield strength / ( \begin{matrix}thermal expansion coefficient \times \\ Young ' s modulus\end{matrix} ) \leq Δ T \leq {T}^{*} - {T}_{part 2}$$

$$or , \\ m \frac{{S}_{Y}}{α E} \leq Δ T \leq {T}^{*} - {T}_{part 2}$$

where,

ΔT: Tₚₐᵣₜ₁−Tₚₐᵣₜ₂, i.e. temperature difference between Part 1 and Part 2.

S_{γ}: Material yield strength of Part 1 in unit of [Pascal] or [MPa]

E: Material Young's modulus of Part 1 in unit of [Pascal] or [MPa]

α: Material thermal expansion coefficient of Part 1 in unit of

$$[ \frac{1}{° C .} ]$$

T*: Part 1 material characteristic temperature above which material property degration occurs for intended applications

m: Dimensionless scaling parameter that varies between 0.2 to 0.4, depending on specific combinations of dissimilar materials to be joined

By way of non-limiting example, the temperature differential (ΔT) for the following metal pairs is illustrated herein. The first example is the joining of steel and aluminum: assuming that Part 1 is a low-carbon steel part (S_{γ}=360 MPa, E=210,000 MPa, α=1.16×10⁻⁵° C.⁻¹, T*=200° C.) and Part 2 is an aluminum alloy part (S_{γ}=278 MPa, E=70,000 MPa, α=2.35×10⁻⁵° C.⁻¹, T*=120° C.)., the resulting temperature differential ranges from 44° C. to (200° C.−Tₚₐᵣₜ₂), i.e., 44° C.≦ΔT≦200° C.−Tₚₐᵣₜ₂ if m=0.3. The second example is the joining of a high strength steel part to a low or medium strength steel part. Assuming that Part 1 is a high-strength steel part (S_{γ}=855 MPa, E=202000 MPa, α=1.2×10⁻⁵° C.⁻¹, T*=200° C.) and Part 2 is low-carbon steel (S_{γ}=278 MPa, E=202000 MPa, α=1.2×10⁻⁵° C.⁻¹, T*=200° C.)., the resulting temperature differential ranges from ranges from 106° C. to (200° C.−Tₚₐᵣₜ₂), i.e., 106° C.≦ΔT≦200° C.−Tₚₐᵣₜ₂ if m=0.3.

As shown in the second example, the temperature of Part 1 to achieve the desirable ΔT of 106° C. in the temperature differential method is 131° C., assuming Part 2 being at room temperature of 25° C., which is well below traditional welding pre-heat/post-heat temperatures typically used for welding high-strength steels, typically ranging from 200° C. to about 350° C. for joining high-strength steel parts in order to sufficiently reduce cooling rate without causing excessive hardened microstructures with poor ductility.

As should be understood, the present method performs the welding process when the first member and second member are placed together and the temperature of the first member is greater than the temperature of the second member by the temperature differential (ΔT). For joining dissimilar metals (with different thermal expansion coefficients (α)), the same parameters outlined herein apply. It is desirable, through joint design, that the metals of Part 1 have higher Eα.

According to some embodiments, the present teachings provide numerous advantages, including but not limited to:

1. Simple process concept and easy to implement in mass-production environment.

2. Relatively small ΔT with respect to Part 2, which eliminates any potential degradation effects on material properties in component.

3. Significantly reducing weld hot cracking (during welding) and cold cracking (immediately or shortly after welding), and improving overall weld quality.

4. Significantly reducing weld residual stresses for improved structural performance in terms of static/dynamic strengths and fatigue strength.

5. Significantly reducing detrimental effects of intermetallics in dissimilar metal joints such as in steel to aluminum joints on joint performance since the pre-set temperature differential in the present teachings can reduce tensile stresses at joint region or put the joint region into compression during and after welding.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of joining dissimilar metal parts with a closed bond line or a closed weld seam, the method comprising:
providing a first member;
providing a second member being positioned relative to the first member;
preheating the first member to a first temperature that is less than a temperature that results in predetermined degradation of material properties in the first member;
maintaining the second member at a second temperature to maintain a predetermined temperature differential (ΔT) between the second temperature and the first temperature; and
welding the first member and the second member together while the temperature differential is maintained.

2. The method according to claim 1 wherein the temperature differential (ΔT) is defined as:
$$m \frac{{S}_{Y}}{α E} \leq Δ T \leq {T}^{*} - {T}_{member 2}$$
where,
S_{γ} Material yield strength of the first member in unit of [Pascal] or [MPa];
E: Material Young's modulus of the first member in unit of [Pascal] or [MPa];
α: Material thermal expansion coefficient of the first member in unit of
$$[ \frac{1}{° C .} ] ;$$
T*: Part 1 material characteristic temperature above which material property degradation occurs for intended applications; and
m: Dimensionless scaling parameter that varies between 0.2 to 0.4.

3. The method according to claim 1 wherein the first temperature is greater than an ambient temperature.

4. The method according to claim 1 wherein the first temperature is equal to an ambient temperature.

5. The method according to claim 1 wherein the first temperature is less than an ambient temperature.

6. The method according to claim 1 wherein the first temperature is greater than said second temperature by said temperature differential.

7. The method according to claim 1 wherein the temperature differential is maintained irrespective of variation of the first temperature or the second temperature.

8. The method according to claim 1 wherein the second temperature of the second member is maintained at an ambient temperature.

9. The method according to claim 1 wherein the second temperature is less than an ambient temperature.

10. The method according to claim 1 wherein the second temperature is greater than an ambient temperature.

11. The method according to claim 1 wherein the second member is positioned concentrically relative to the first member.
